(19) United States
(12) Patent Application Publication
(10) Pub. No.: US 2024/0262174 A1
(43) Pub. Date: Aug. 8, 2024

(54) VEHICLE DRIVING APPARATUS

(71) Applicant: Honda Motor Co., Ltd., Tokyo (JP)

(72) Inventors: Kei YOSHINAGA, Tokyo (JP); Takuto KANASE, Tokyo (JP); Takuji YANO, Tokyo (JP); Makoto TSUCHIHASHI, Tokyo (JP)

(73) Assignee: Honda Motor Co., Ltd., Tokyo (JP)

(21) Appl. No.: 18/500,135

(22) Filed: Nov. 2, 2023

(30) Foreign Application Priority Data
Feb. 8, 2023 (JP) 2023-017999

(51) Int. Cl. B60K 1/00; B60K 17/04; B60L 50/60; B60L 53/22; B60R 16/02

(52) U.S. Cl. CPC B60K 1/00; B60K 17/04; B60L 50/60; B60L 53/22; B60R 16/0207; B60K 2001/001; F16H 57/02; F16H 2057/02026; F16H 2057/02034; F16H 2057/02052; F16H 63/3466

(57) ABSTRACT

A vehicle driving apparatus (1) integrates an electric motor (10) that is a drive source of a vehicle (100), a power conversion device (30) that is electrically connected to the electric motor (10), and a power transmission mechanism (50) that transmits rotation of power from the electric motor (10). An axial direction of a rotating shaft of the electric motor (10) is arranged in a vehicle width direction. The power conversion device (30) and the power transmission mechanism (50) are respectively arranged on one side and the other side of the electric motor (10) in the vehicle width direction. The power conversion device (30) is provided with a connector part (39) to which power wiring (40) is connected. The connector part (39) is arranged to draw out the power wiring (40) from the power conversion device (30) in the vehicle width direction.

### CROSS-REFERENCE TO RELATED APPLICATION

This application claims the priority benefits of Japanese application no. 2023-017999, filed on Feb. 8, 2023. The entirety of the above-mentioned patent application is hereby incorporated by reference herein and made a part of this specification.

### BACKGROUND

### Technical Field

The disclosure relates to a vehicle driving apparatus mounted on a vehicle, and more particularly relates to a vehicle driving apparatus that includes an electric motor mounted on an electric vehicle or the like as a drive source.

### Description of Related Art

There are vehicles such as electric vehicles and hybrid vehicles that use an electric motor as a drive source. Such vehicles are equipped with an electric motor and a power conversion device that is electrically connected to the electric motor and converts the electric power supplied to the electric motor and the electric power supplied from the electric motor. Conventionally, the electric motor and the power conversion device are electrically connected using three-phase wires, but in recent years, attempts have been made to directly fix the electric motor and the power conversion device to form a unit, as shown in Patent Document 1 (Japanese Patent Application Laid-Open No. 2021-10270), for example. Recently, a unit (so-called electromechanical-integrated electric driving apparatus) formed by integrating not only the electric motor and the power conversion device but also a power transmission mechanism (deceleration mechanism) for changing the speed (decelerating) of the rotation of power from the electric motor and transmitting it to the drive wheel side of the vehicle has been adopted.

Further, the power conversion device is provided with a connector part to which a DC cable connected to a battery is connected. The connector part has an internal connection part connected to a conductive member disposed inside the power conversion device, and the power conversion device converts DC power transmitted from the DC cable into AC power, or conversely converts AC power transmitted from the electric motor into DC power.

In the electromechanical-integrated electric driving apparatus described above, power wiring such as the DC cable is an important component for supplying the power source to the electric motor, and since the power wiring needs to be compatible with high voltage and EMC (electromagnetic compatibility), the power wiring has a thick coating, a large diameter, and low flexibility. Therefore, how to establish a wiring layout to avoid functional defects caused by interference with adjacent components becomes an issue.

Regarding the power wiring as mentioned above, conventionally, in order to ensure the passage of wiring with little flexibility in bending, the connection position of the power wiring according to each model (vehicle type), in which the electric driving apparatus is mounted, and each mounting position has been set individually so as to prevent the power wiring itself from being bent excessively. However, in terms of improving the routing of power wiring and suppressing an increase in vehicle costs, there is room for further improvement, such as standardizing the power wiring connection structure and wiring structure for each model (vehicle type) and each mounting position.

The disclosure provides a vehicle driving apparatus that is capable of improving the routing of connected power wiring with a simple and compact configuration, effectively increasing the degree of freedom in the layout of the apparatus and peripheral structures, and reducing the costs of the apparatus and the vehicle by standardizing the power wiring connection structure and wiring structure for each model (vehicle type) and each mounting position.

### SUMMARY

The vehicle driving apparatus according to the disclosure is a vehicle driving apparatus (1), integrating an electric motor (10) that is a drive source of a vehicle (100), a power conversion device (30) that is electrically connected to the electric motor (10) and converts electric power supplied to the electric motor (10) and electric power supplied from the electric motor (10), and a power transmission mechanism (50) for transmitting rotation of power from the electric motor (10) to a drive wheel (FW, RW) side of the vehicle (100). An axial direction of a rotating shaft of the electric motor (10) is arranged in a vehicle width direction of the vehicle (100). The power conversion device (30) and the power transmission mechanism (50) are respectively arranged on one side and the other side of the electric motor (10) in the vehicle width direction. The power conversion device (30) is provided with a connector part (39) to which power wiring (40) is connected. The connector part (39) is arranged to draw out the power wiring (40) from the power conversion device (30) in the vehicle width direction.

### BRIEF DESCRIPTION OF THE DRAWINGS

FIG. 1 is a perspective view showing the external configuration of the vehicle driving apparatus according to an embodiment of the disclosure.

FIG. 2A is a plan view and FIG. 2B is a side view showing the external configuration of the vehicle driving apparatus.

FIG. 3A and FIG. 3B are schematic side views of the vehicle equipped with the vehicle driving apparatus, wherein FIG. 3A is a view showing a case where the vehicle driving apparatus is used as a front wheel drive unit and FIG. 3B is a view showing a case where the vehicle driving apparatus is used as a rear wheel drive unit.

FIG. 4 is a view showing a case where the vehicle driving apparatus is used as a front wheel drive unit, and is a view showing the vehicle driving apparatus mounted on the vehicle and the periphery thereof.

FIG. 5A and FIG. 5B are views showing a case where the vehicle driving apparatus is used as a front wheel drive unit, and are views showing the wiring structure of the DC cable connected to the vehicle driving apparatus.

FIG. 6 is a view showing a case where the vehicle driving apparatus is used as a rear wheel drive unit, and is a view showing the vehicle driving apparatus mounted on the vehicle and the periphery thereof.

FIG. 7A and FIG. 7B are views showing a case where the vehicle driving apparatus is used as a rear wheel drive unit, and are views showing the wiring structure of the DC cable connected to the vehicle driving apparatus.

### DESCRIPTION OF THE EMBODIMENTS

The vehicle driving apparatus according to the disclosure is a vehicle driving apparatus (1), integrating an electric motor (10) that is a drive source of a vehicle (100), a power conversion device (30) that is electrically connected to the electric motor (10) and converts electric power supplied to the electric motor (10) and electric power supplied from the electric motor (10), and a power transmission mechanism (50) for transmitting rotation of power from the electric motor (10) to a drive wheel (FW, RW) side of the vehicle (100). An axial direction of a rotating shaft of the electric motor (10) is arranged in a vehicle width direction of the vehicle (100). The power conversion device (30) and the power transmission mechanism (50) are respectively arranged on one side and the other side of the electric motor (10) in the vehicle width direction. The power conversion device (30) is provided with a connector part (39) to which power wiring (40) is connected. The connector part (39) is arranged to draw out the power wiring (40) from the power conversion device (30) in the vehicle width direction.

According to the vehicle driving apparatus of the disclosure, the axial direction of the rotating shaft of the electric motor is arranged in the vehicle width direction of the vehicle, the power conversion device and the power transmission mechanism are respectively arranged on one side and the other side of the electric motor in the vehicle width direction, and the connector part of the power conversion device is arranged to draw out the power wiring from the power conversion device in the vehicle width direction. Thus, even if sufficient surplus space cannot be secured around the vehicle driving apparatus, the power wiring drawn out from the power conversion device may still be wired appropriately. In particular, it is possible to properly lay out power wiring, which has a thick coating, a large diameter, and low flexibility, without excessive bending.

Further, in the vehicle driving apparatus of the disclosure, the connector part (39) may be arranged to draw out the power wiring (40) from the power conversion device (30) toward the side of the electric motor (10) in the vehicle width direction.

According to this configuration, the connector part is arranged to draw out the power wiring from the power conversion device toward the electric motor side in the vehicle width direction, which provides the space for wiring the power wiring on the electric motor side in the vehicle width direction (not in the front-rear direction of the vehicle) with respect to the power conversion device. Therefore, a common vehicle driving apparatus may be used regardless of whether the vehicle driving apparatus is mounted at the front or rear of the vehicle.

Further, in the vehicle driving apparatus of the disclosure, at least a part of a peripheral edge of the power transmission mechanism (50) may be provided with a power wiring space (S) for wiring the power wiring (40) drawn out from the connector part (39).

According to this configuration, providing the power wiring space on the connector part side of the power transmission mechanism may effectively improve the spatial efficiency around the vehicle driving apparatus.

Furthermore, in the vehicle driving apparatus of the disclosure, the power wiring space (S) may be formed by a chamfered part (58f) that is formed by chamfering at least a part of an upper end (58e) of the power transmission mechanism (50).

According to this configuration, since the power wiring space may be provided by utilizing the arc outer peripheral shape of the gear included in the power transmission mechanism, the spatial efficiency around the vehicle driving apparatus may be more effectively improved.

Further, the power transmission mechanism (50) may include a final shaft (55) that transmits rotation generated by power of the electric motor (10) to a drive wheel (FW, RW) of the vehicle (100), and the power wiring space (S) may be arranged above the final shaft (55) in the power transmission mechanism (50).

In the power transmission mechanism, structures such as the final shaft that transmits the rotation generated by the power of the electric motor to the drive wheels of the vehicle and the final gear provided on the final shaft are arranged around the drive shafts connected to the drive wheels of the vehicle, and are therefore at a relatively low position of the vehicle. Since a relatively large space may be secured above the final shaft in the power transmission mechanism, arranging the power wiring space above the final shaft may secure a space sufficiently increasing the degree of freedom in wiring and layout of the power wiring.

Further, in the vehicle driving apparatus of the disclosure, the power transmission mechanism (50) may integrally include a component (59) of a parking mechanism for performing parking lock of the vehicle (100), and the power wiring space (S) and the component (59) of the parking mechanism may be provided on opposite sides of the power transmission mechanism (50) in a front-rear direction of the vehicle (100).

According to this configuration, the power wiring space and the component of the parking mechanism are provided on opposite sides of the power transmission mechanism in the front-rear direction of the vehicle, which may secure the power wiring space without increasing the size of the power transmission mechanism even when the component of the parking mechanism is integrated with the power transmission mechanism. Accordingly, the degree of freedom in wiring and layout of the power wiring may be sufficiently increased.

It should be noted that the symbols in parentheses above indicate drawing reference numerals of corresponding components in the embodiments to be described later for reference.

The vehicle driving apparatus according to the disclosure is capable of improving the routing of connected power wiring with a simple and compact configuration, effectively increasing the degree of freedom in the layout of the apparatus and peripheral structures, and reducing the costs of the apparatus and the vehicle by standardizing the connection structure and wiring structure for each model (vehicle type) and each mounting position.

Embodiments of the disclosure will be described in detail below with reference to the accompanying drawings. In the following description, the terms “front” and “rear” respectively refer to the front side, which is the forward direction of the vehicle (vehicle body), and the rear side, which is the rearward direction of the vehicle (vehicle body), which will be described later. In addition, the terms “up,” “down,” “left,” and “right” respectively refer to the upper side, lower side, left side, and right side when facing the forward direction (front side) of the vehicle (vehicle body).

### [Vehicle Driving Apparatus]

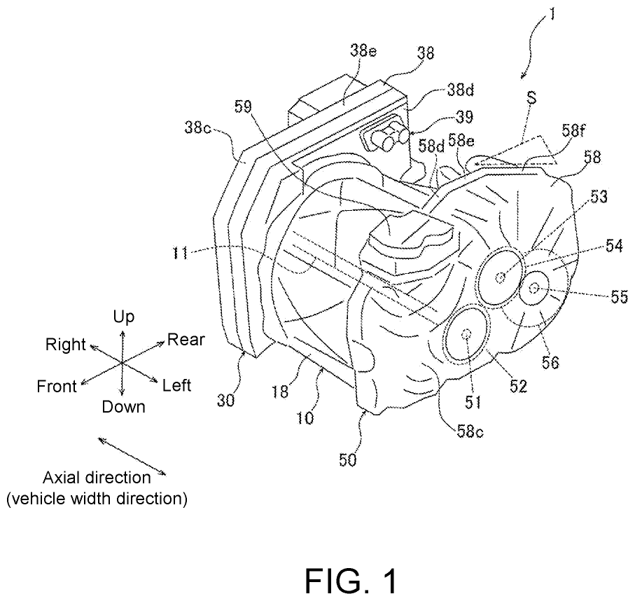

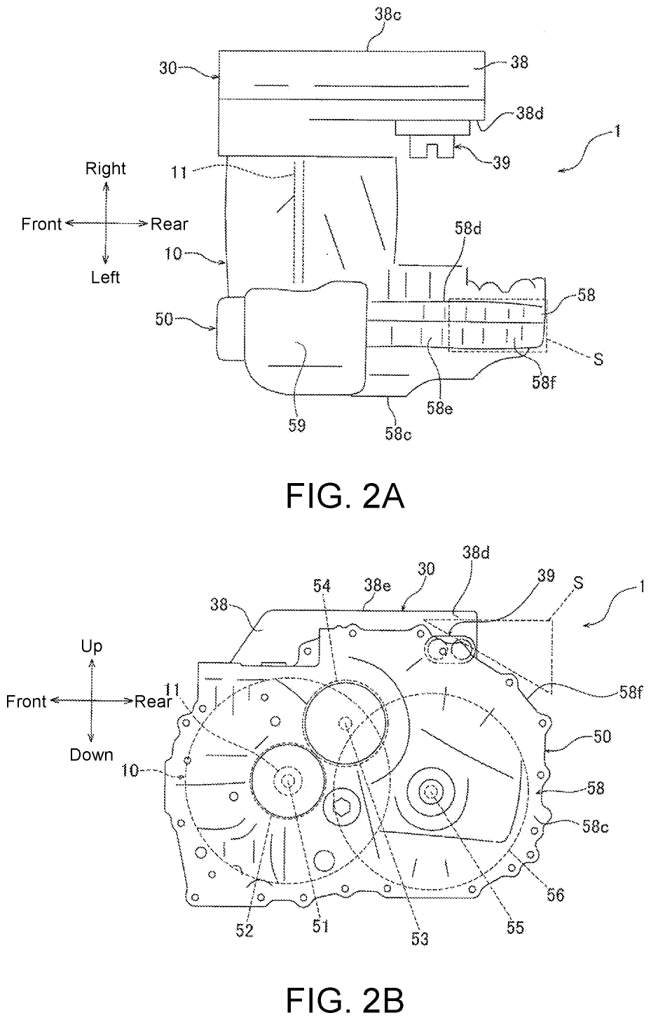

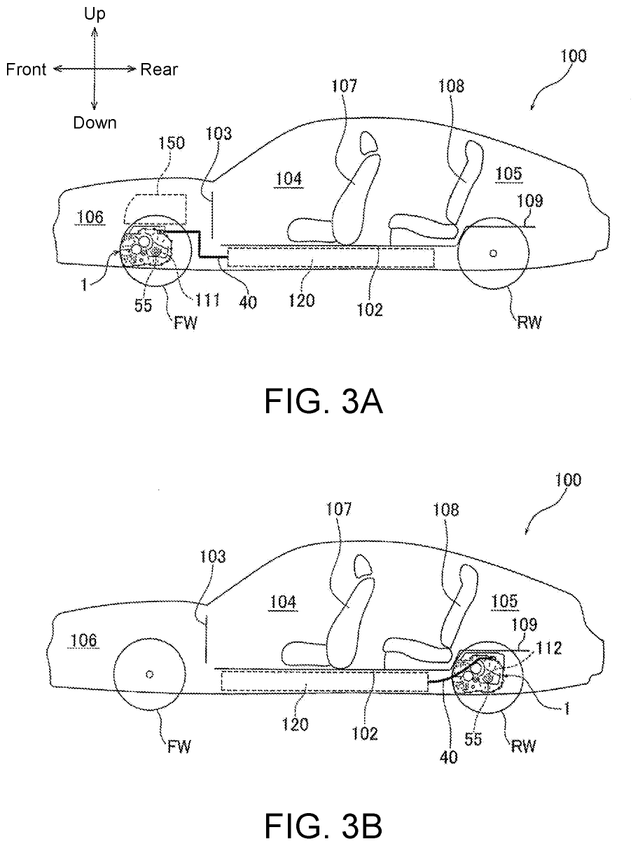

FIG. 1, FIG. 2A, and FIG. 2B are views showing the external configuration of a vehicle driving apparatus according to an embodiment of the disclosure, wherein FIG. 1 is a perspective view, FIG. 2A is a plan view, and FIG. 2B is a side view. Further, FIG. 3A and FIG. 3B are schematic side views of a vehicle equipped with the vehicle driving apparatus, wherein FIG. 3A is a view showing a case where the vehicle driving apparatus is used as a front wheel drive unit and FIG. 3B is a view showing a case where the vehicle driving apparatus is used as a rear wheel drive unit. As shown in these drawings, the vehicle driving apparatus 1 is an apparatus that integrates an electric motor 10, a power conversion device 30 that is electrically connected to the electric motor 10 and converts the electric power supplied to the electric motor 10 and the electric power supplied from the electric motor 10, and a power transmission mechanism 50 that transmits the power of the electric motor 10 to drive wheels (front wheels FW or rear wheels RW) of a vehicle 100. The power conversion device 30 is, for example, an inverter.

In the vehicle driving apparatus 1, the axial direction of a rotating shaft 11 of the electric motor 10 is arranged in a vehicle width direction of the vehicle 100, and the power conversion device 30 and the power transmission mechanism 50 are respectively arranged on the right side (one side) and the left side (the other side) of the electric motor 10 in the vehicle width direction. That is, the electric motor 10 has a substantially cylindrical shape, and the rotating shaft (drive shaft) 11 thereof extends substantially horizontally in the vehicle width direction. The rotating shaft 11 is the rotation axis of the electric motor 10. The power transmission mechanism 50 is arranged in line with the electric motor 10 in the vehicle width direction so that the axis of a motor shaft 51, which will be described later, is coaxial with the rotating shaft 11 of the electric motor 10.

The power transmission mechanism 50 has a structure including a plurality of rotating shafts (motor shaft 51, counter shaft 53, final shaft 55) arranged parallel to each other and a plurality of gears (motor gear 52, counter gear 54, final gear 56) fixed to the rotating shafts, and includes the motor shaft (first rotating shaft) 51 arranged coaxially with the rotating shaft 11 of the electric motor 10 and the motor gear 52 rotating around the motor shaft 51, the counter shaft (second rotating shaft) 53 arranged parallel to the motor shaft 51 and the counter gear 54 rotating around the counter shaft 53, and the final shaft (third rotating shaft) 55 arranged parallel to the motor shaft 51 and the counter shaft 53 and the final gear 56 rotating around the final shaft 55. The rotation of the power transmitted from the electric motor 10 is transmitted from the motor gear 52 to the counter gear 54, further transmitted from the counter gear 54 to the final gear 56, and transmitted from the final gear 56 to a drive shaft 111 or a drive shaft 112 and the drive wheels (front wheels FW or rear wheels RW) of the vehicle 100.

Components such as the rotating shafts and gears included in the power transmission mechanism 50 are arranged inside a power transmission mechanism case 58. The power transmission mechanism case 58 is formed by joining an outer case and an inner case at an intermediate joint surface in the axial direction, and the outer shape of the power transmission mechanism case 58 is formed into a substantially rectangular box shape with the thickness direction being in the vehicle width direction, the width direction being in the front-rear direction of the vehicle 100, and the height direction being in the up-down direction. This power transmission mechanism case 58 has an outer surface (right side surface) 58c, an inner surface (left side surface) 58d, and an upper end (upper end side) 58e. The power transmission mechanism case 58 is fixed to an electric motor case 18 so that the inner surface 58d faces the left end surface of the electric motor case 18. Inside the power transmission mechanism case 58, the motor shaft 51 and the motor gear 52 are arranged at the middle stage on the front side, the counter shaft 53 and the counter gear 54 are arranged at the upper stage in the middle in the front-rear direction, and the final shaft 55 and the final gear 56 are arranged at the lower stage on the rear side.

Furthermore, components of a parking mechanism for parking lock of the vehicle 100 are housed inside the power transmission mechanism case 58. Although detailed illustration and description of the parking mechanism are omitted, a mechanism for locking a parking gear provided on the motor shaft 51 is housed in the front inside the power transmission mechanism case 58, and a parking actuator 59 composed of an electric motor or the like for rotating a parking rod is installed at the upper end 58e on the front side of the power transmission mechanism case 58.

The power conversion device 30 has a power conversion device case 38. The power conversion device case 38 has a substantially rectangular parallelepiped shape, and includes an outer surface 38c, an inner surface 38d, and an upper end 38e. The power conversion device case 38 is fixed to the electric motor case 18 so that the inner surface 38d of the power conversion device case 38 faces the right end surface of the electric motor case 18.

### [DC Connector]

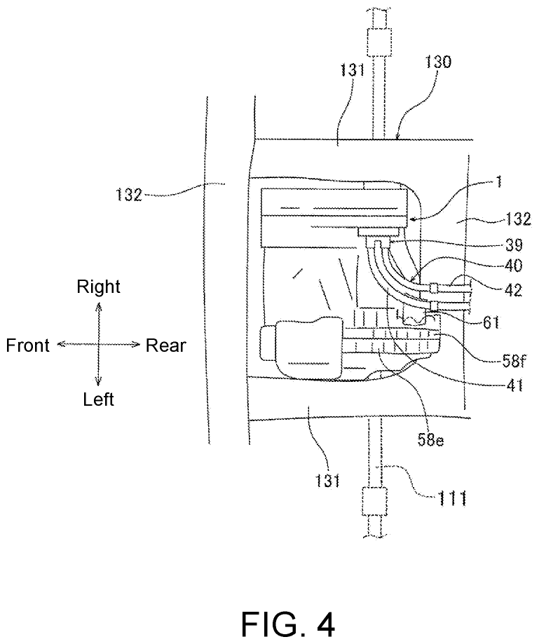

A connector part 39 to which a DC cable (power wiring) 40 (see FIG. 4) is connected is provided on the inner surface 38d of the power conversion device case 38 to face the left side in the vehicle width direction. The connector part 39 is arranged near the upper end 38e on the rear side of the inner surface 38d of the power conversion device case 38, and a root portion of the connected DC cable 40 is provided to be drawn out substantially perpendicularly to the inner surface 38d (that is, substantially horizontally toward the left side in the vehicle width direction). As shown in FIG. 2B, the connector part 39 is provided at a position opposite to a chamfered part (cutout part) 58f provided at the upper end 58e on the rear side of the power transmission mechanism case 58. That is, the connector part 39 of the power conversion device case 38 and the chamfered part 58f of the power transmission mechanism case 58 are arranged at substantially the same position when viewed from the vehicle width direction (a position where the connector part 39 and the chamfered part 58f overlap when viewed from the vehicle width direction).

### [Vehicle]

Next, the vehicle equipped with the vehicle driving apparatus 1 will be described. The vehicle 100 of this embodiment is an electric vehicle that uses the vehicle driving apparatus 1 shown in FIG. 1, FIG. 2A, and FIG. 2B as a drive source. As shown in FIG. 3A and FIG. 3B, the vehicle 100 includes a vehicle compartment 104 and a luggage compartment 105, which are defined by a floor panel 102, a dash panel 103, and a luggage compartment floor panel 109, and a front room 106 in front of the vehicle compartment 104. The vehicle compartment 104 is provided with a front seat 107 and a rear seat 108.

In the case where the vehicle 100 of this embodiment uses the vehicle driving apparatus 1 as a unit (front wheel drive unit) for driving the front wheels FW, as shown in FIG. 3A, the vehicle driving apparatus 1 is mounted at a front position of the vehicle 100 corresponding to the front wheels FW. Specifically, the vehicle driving apparatus 1 is installed between the left and right front wheels FW in the front room 106, and the final shaft 55 of the vehicle driving apparatus 1 is arranged coaxially with the drive shaft 111 of the front wheels FW. Further, in the case of using the vehicle driving apparatus 1 as a unit (rear wheel drive unit) for driving the rear wheels RW, as shown in FIG. 3B, the vehicle driving apparatus 1 is mounted at a rear position of the vehicle 100 corresponding to the rear wheels RW. Specifically, the vehicle driving apparatus 1 is installed between the left and right rear wheels RW below the luggage compartment 105, and the final shaft 55 of the vehicle driving apparatus 1 is arranged coaxially with the drive shaft 112 of the rear wheels RW. In this way, the vehicle driving apparatus 1 of this embodiment may be used as a drive unit for driving the front wheels or a drive unit for driving the rear wheels of the vehicle 100. The following illustrates a wiring structure for the DC cable (power wiring) 40 when using the vehicle driving apparatus 1 as a drive unit for driving the front wheels and as a drive unit for driving the rear wheels, respectively.

### [When Using the Vehicle Driving Apparatus as a Unit for Driving the Front Wheels]

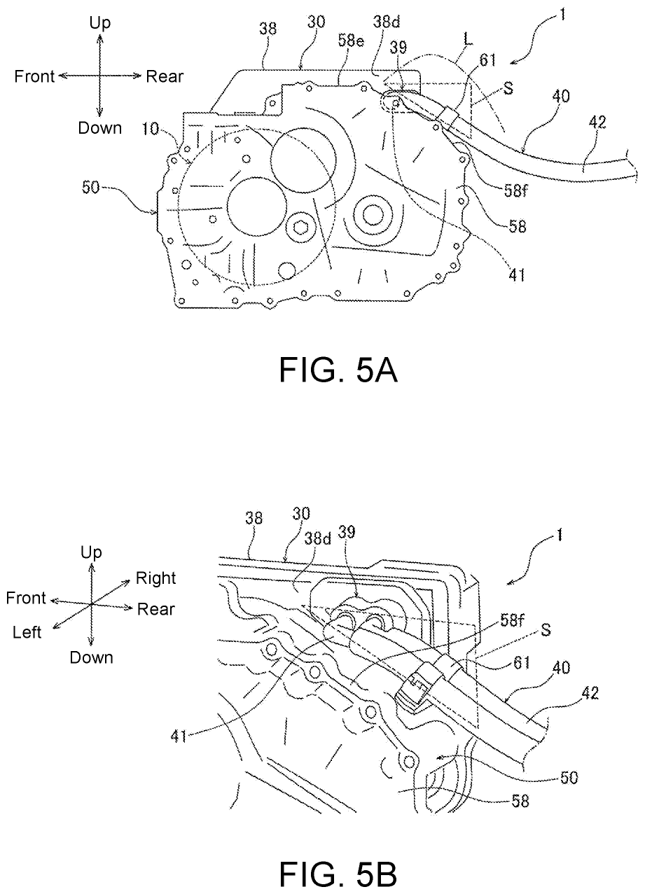

FIG. 4, FIG. 5A, and FIG. 5B are views showing a case where the vehicle driving apparatus is used as a unit for driving the front wheels, wherein FIG. 4 is a view showing the vehicle driving apparatus mounted on the vehicle and the periphery thereof, and FIG. 5A and FIG. 5B are views showing the wiring structure of the DC cable connected to the vehicle driving apparatus. When the vehicle driving apparatus 1 is used as a unit for driving the front wheels, the vehicle driving apparatus 1 is mounted at a position corresponding to the front wheels FW of the vehicle 100. That is, as shown in FIG. 4, a subframe 130 is provided below the front room 106 (see FIG. 3A) of the vehicle 100. The subframe 130 includes a pair of left and right side members 131 extending along the front-rear direction, and cross members 132 extending along the vehicle width direction and respectively connecting the front edges and rear edges of the two side members 131, so that the entire subframe 130 is formed in a parallel cross shape. Then, the vehicle driving apparatus 1 is supported inside the subframe 130 formed in a parallel cross shape.

In this case, as shown in FIG. 3A, a high voltage electrical device 150 is mounted in the front room 106 at a position right above (directly above) the vehicle driving apparatus 1. The high voltage electrical device 150 is an electrical device of high voltage including, for example, an AC to DC converter or the like. Arranging the high voltage electrical device 150 directly above the vehicle driving apparatus 1 in this way brings the benefits such as keeping the route length of high voltage cables short to reduce the costs and cooling the vehicle driving apparatus 1 and the high voltage electrical device 150 together to reduce the cooling water distribution routes.

Further, in this case, as shown in FIG. 3A and FIG. 4, the vehicle driving apparatus 1 mounted at a position corresponding to the front wheels FW of the vehicle 100 and the battery 120 disposed below the vehicle compartment 104 are connected by the DC cable 40. Therefore, the DC cable 40 attached to the connector part 39 of the vehicle driving apparatus 1 is drawn out from the connector part 39 toward the left side in the vehicle width direction, the tip portion thereof is a bent portion 41 bent approximately 90 degrees toward the rear of the vehicle 100, and the tip of the bent portion 41 extends toward the rear of the vehicle 100. As shown in FIG. 4, FIG. 5A, and FIG. 5B, the bent portion 41 is arranged between the power conversion device 30 and the power transmission mechanism 50 in the vehicle width direction (at a position behind and diagonally above the electric motor 10) and is bent toward the rear in a substantially horizontal plane (at the same height), and an extending portion 42 extending in a substantially straight line beyond the bent portion 41 extends toward the rear by passing above the upper end 58e of the power transmission mechanism case 58 (the upper end 58e at a position corresponding to the chamfered part 58f). The extending portion 42 of the DC cable 40 is fixed to the upper end 58e (chamfered part 58f) of the power transmission mechanism case 58 via a stay (locking tool) 61.

### [When Using the Vehicle Driving Apparatus as a Unit for Driving the Rear Wheels]

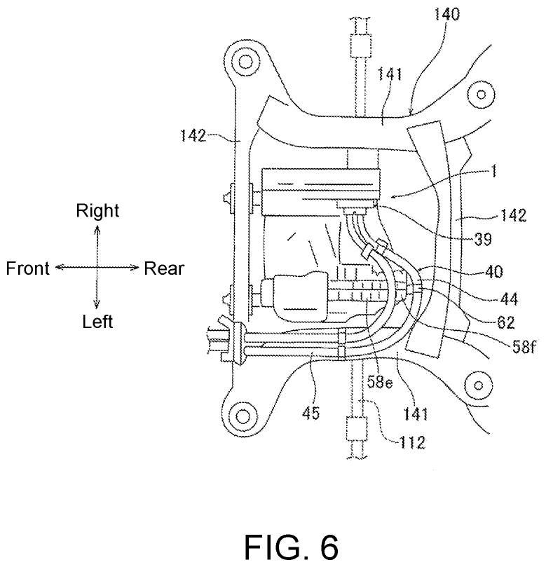

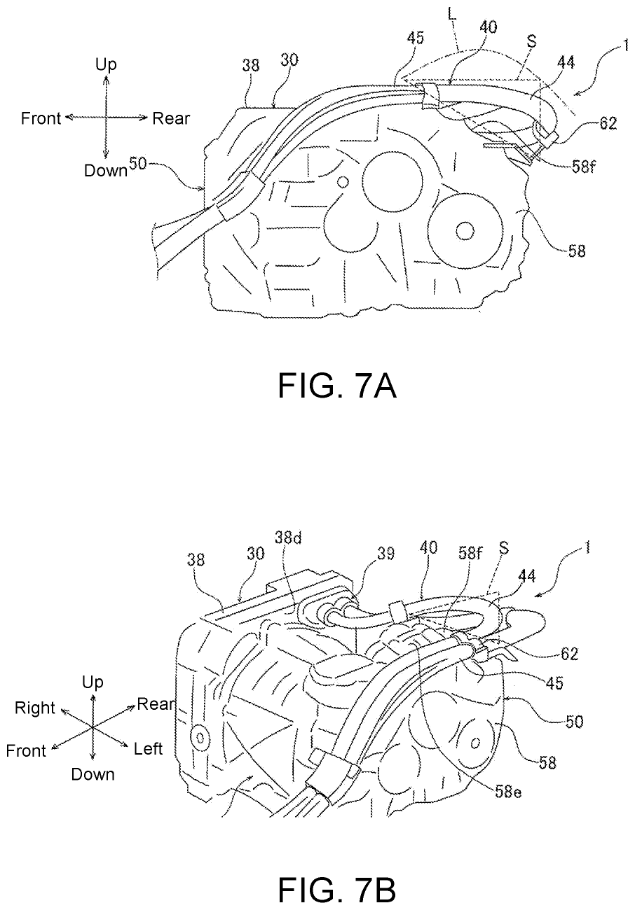

FIG. 6, FIG. 7A, and FIG. 7B are views showing a case where the vehicle driving apparatus is used as a unit for driving the rear wheels, wherein FIG. 6 is a view showing the vehicle driving apparatus mounted on the vehicle and the periphery thereof, and FIG. 7A and FIG. 7B are views showing the wiring structure of the DC cable connected to the vehicle driving apparatus. When the vehicle driving apparatus 1 is used as a unit for driving the rear wheels, the vehicle driving apparatus 1 is mounted at a position corresponding to the rear wheels RW of the vehicle 100. That is, as shown in FIG. 6, a subframe 140 is provided below the luggage compartment 105 (see FIG. 3B) of the vehicle 100. The subframe 140 includes a pair of left and right side members 141 extending along the front-rear direction, and cross members 142 extending along the vehicle width direction and respectively connecting the front edges and rear edges of the two side members 141, so that the entire subframe 140 is formed in a parallel cross shape. Then, the vehicle driving apparatus 1 is supported inside the subframe 140 formed in a parallel cross shape.

Further, in this case, as shown in FIG. 3B and FIG. 6, the vehicle driving apparatus 1 mounted at a position corresponding to the rear wheels RW of the vehicle 100 (below the luggage compartment floor panel 109) and the battery 120 disposed below the vehicle compartment 104 (floor panel 102) are connected by the DC cable 40. Therefore, the DC cable 40 attached to the connector part 39 of the vehicle driving apparatus 1 is drawn out from the connector part 39 toward the left side in the vehicle width direction, and the tip thereof is a curved portion 44 that extends in a curved line toward the left side and the rear side in the vehicle width direction and extends further toward the left side while curving to pass above the upper end 58e of the power transmission mechanism case 58 (the upper end 58e at a position corresponding to the chamfered part 58f). This DC cable 40 curves into a substantially semicircular arc shape at the curved portion 44 to change the direction toward the front above the chamfered part 58f, and reaches the side portion (left side portion) of the vehicle driving apparatus 1 (power transmission mechanism 50). Then, an extending portion 45 at the tip extends in a substantially straight line toward the front of the vehicle 100 through the side portion (left side portion) of the vehicle driving apparatus 1 (power transmission mechanism 50). The curved portion 44 of the DC cable 40 is fixed to the upper end 58e (chamfered part 58f) of the power transmission mechanism case 58 via a stay (locking tool) 62.

Here, in the vehicle driving apparatus 1 of this embodiment, the chamfered part 58f is formed by diagonally chamfering the rear portion of the upper end 58e of the power transmission mechanism case 58 when viewed from the vehicle width direction. Thus, a space (wiring space) S for wiring the DC cable 40 is formed above the chamfered part 58f. Accordingly, wiring the DC cable 40 connected from the connector part 39 to the battery 120 in this space S may prevent the DC cable 40 from protruding above the vehicle driving apparatus 1 as indicated by the dashed line L in FIG. 5A and FIG. 7A. Therefore, the spatial efficiency around the vehicle driving apparatus 1 may be effectively improved. In addition, especially when using the vehicle driving apparatus 1 as a drive unit for driving the front wheels, as shown in FIG. 3A, the DC cable 40 may be appropriately wired while allowing the high voltage electrical device 150 to be disposed directly above the vehicle driving apparatus 1. On the other hand, when using the vehicle driving apparatus 1 as a drive unit for driving the rear wheels, as shown in FIG. 3B, since the DC cable 40 may be prevented from protruding above the vehicle driving apparatus 1, the gap between the vehicle driving apparatus 1 and the luggage compartment floor panel 109 located directly above may be kept small. Accordingly, it is possible to lower the height position of the luggage compartment floor panel 109, thereby lowering the floor of the luggage compartment 105 and increasing the accommodation space. Further, although not shown in the drawings, when third row seats are installed in place of the luggage compartment 105, the leg space for the third row seats may be increased.

The vehicle driving apparatus 1 according to this embodiment is an apparatus integrating the electric motor 10 that is a drive source of the vehicle 100, the power conversion device 30 that is electrically connected to the electric motor 10 and converts the electric power supplied to the electric motor 10 and the electric power supplied from the electric motor 10, and the power transmission mechanism 50 for transmitting the rotation of power from the electric motor 10 to the side of the drive wheels FW and RW of the vehicle 100. The axial direction of the rotating shaft 11 of the electric motor 10 is arranged in the vehicle width direction of the vehicle 100. The power conversion device 30 and the power transmission mechanism 50 are respectively arranged on one side and the other side of the electric motor 10 in the vehicle width direction. The power conversion device 30 is provided with the connector part 39 to which the DC cable (power wiring) 40 is connected. The connector part 39 is arranged to draw out the DC cable 40 from the power conversion device 30 in the vehicle width direction.

According to the vehicle driving apparatus 1 of this embodiment, the axial direction of the rotating shaft 11 of the electric motor 10 is arranged in the vehicle width direction of the vehicle 100, the power conversion device 30 and the power transmission mechanism 50 are respectively arranged on one side and the other side of the electric motor 10 in the vehicle width direction, and the connector part 39 of the power conversion device 30 is arranged to draw out the DC cable 40 from the power conversion device 30 in the vehicle width direction. Thus, even if sufficient surplus space cannot be secured around the vehicle driving apparatus 1, the DC cable 40, which has a large diameter and low flexibility and is drawn out from the power conversion device 30, may still be wired appropriately.

That is to say, in the vehicle driving apparatus 1 of this embodiment, the power conversion device 30 is placed horizontally, and the connector part 39 that connects the DC cable 40 is disposed facing inward in the vehicle width direction. Then, the space S formed by the chamfered part 58f provided above the final shaft 55 of the power transmission mechanism 50, which is arranged on the opposite side across the electric motor 10, is utilized to secure the position for drawing out the DC cable 40. Thereby, the connection structure (wiring structure) of the DC cable 40, which allows the vehicle driving apparatus 1 having the same structure to be used as both the front wheel drive unit and the rear wheel drive unit, is realized.

Furthermore, in this embodiment, the connector part 39 is arranged to draw out the DC cable 40 from the power conversion device 30 toward the side of the electric motor 10 in the vehicle width direction.

According to this configuration, the connector part 39 is arranged to draw out the DC cable 40 from the power conversion device 30 toward the side of the electric motor 10 in the vehicle width direction, which provides the space for wiring the DC cable 40 on the side of the electric motor 10 in the vehicle width direction (not in the front-rear direction of the vehicle 100) with respect to the power conversion device 30. Therefore, a common vehicle driving apparatus 1 may be used regardless of whether the vehicle driving apparatus 1 is mounted at the front or rear of the vehicle 100.

Furthermore, in this embodiment, the space S for wiring the DC cable 40 drawn out from the connector part 39 is provided at a peripheral edge of the power transmission mechanism 50 (power transmission mechanism case 58). Specifically, this space S is a space formed by the chamfered part 58f that is formed by chamfering the upper end 58e of the power transmission mechanism 50. Then, the chamfered part 58f is provided as a portion formed by diagonally chamfering the rear of the upper end 58e of the power transmission mechanism case 58 when viewed from the vehicle width direction.

Additionally, in this embodiment, the power transmission mechanism 50 includes the final shaft 55 that transmits the rotation generated by the power of the electric motor 10 to the drive wheels FW and RW of the vehicle 100, and the space S for wiring the power wiring is arranged above the final shaft 55 in the power transmission mechanism 50.

According to this configuration, the space S that is the wiring space for the DC cable 40 is provided on the side of the connector part 39 of the power transmission mechanism 50, which utilizes the arc outer peripheral shape of the gear (final gear 56) installed in the power transmission mechanism case 58 to provide the space S that is the wiring space for the DC cable 40, so the spatial efficiency around the vehicle driving apparatus 1 may be effectively improved.

Moreover, in the power transmission mechanism 50, structures such as the final shaft 55 that transmits the rotation generated by the power of the electric motor 10 to the drive wheels FW and RW of the vehicle 100 and the final gear 56 provided on the final shaft 55 are arranged around the drive shafts 111 and 112 connected to the drive wheels FW and RW of the vehicle 100, and are therefore at a relatively low position of the vehicle 100. Since a relatively large space may be secured above the final shaft 55 in the power transmission mechanism 50, arranging the space S for wiring the DC cable 40 above (directly above) the final shaft 55 may secure a space sufficiently increasing the degree of freedom in wiring and layout of the DC cable 40.

Furthermore, in this embodiment, the power transmission mechanism 50 integrally includes the parking actuator 59 which is a component of the parking mechanism for parking lock of the vehicle 100. Then, in the power transmission mechanism 50, the parking actuator 59 is provided on the front side and the space S is provided on the rear side in the front-rear direction of the vehicle 100.

According to this configuration, the space S for wiring the power wiring and the parking actuator 59 are provided on opposite sides of the power transmission mechanism 50 in the front-rear direction of the vehicle 100, which may secure the space S for wiring the DC cable 40 without increasing the size of the power transmission mechanism 50 even when the parking actuator 59 is integrated with the power transmission mechanism 5. Accordingly, the degree of freedom in wiring and layout of the DC cable 40 may be sufficiently increased.

Although the embodiments of the disclosure have been described above, the disclosure is not limited to the above embodiments, and it is possible to make various changes within the scope of the technical idea described in the claims, specification, and drawings.

For example, the above embodiments illustrate a case where the vehicle 100 is an electric vehicle using only the electric motor 10 as a drive source, but the vehicle driving apparatus of the disclosure may also be installed in a hybrid vehicle that uses an engine (internal combustion engine) and an electric motor as the drive sources. In that case, for example, the front wheels of the vehicle may be the main drive wheels driven by the engine (internal combustion engine), and the rear wheels may be the auxiliary drive wheels driven by the vehicle driving apparatus (electric motor 10) of this embodiment.

What is claimed is:

1. A vehicle driving apparatus, integrating an electric motor that is a drive source of a vehicle, a power conversion device that is electrically connected to the electric motor and converts electric power supplied to the electric motor and electric power supplied from the electric motor, and a power transmission mechanism for transmitting rotation of power from the electric motor to a drive wheel side of the vehicle,
wherein an axial direction of a rotating shaft of the electric motor is arranged in a vehicle width direction of the vehicle,
the power conversion device and the power transmission mechanism are respectively arranged on one side and the other side of the electric motor in the vehicle width direction,
the power conversion device is provided with a connector part to which power wiring is connected, and
the connector part is arranged to draw out the power wiring from the power conversion device in the vehicle width direction.

2. The vehicle driving apparatus according to claim 1, wherein the connector part is arranged to draw out the power wiring from the power conversion device toward the side of the electric motor in the vehicle width direction.

3. The vehicle driving apparatus according to claim 1, wherein at least a part of a peripheral edge of the power transmission mechanism is provided with a power wiring space for wiring the power wiring drawn out from the connector part.

4. The vehicle driving apparatus according to claim 2, wherein at least a part of a peripheral edge of the power transmission mechanism is provided with a power wiring space for wiring the power wiring drawn out from the connector part.

5. The vehicle driving apparatus according to claim 3, wherein the power wiring space is a space formed by a chamfered part that is formed by chamfering at least a part of an upper end of the power transmission mechanism.

6. The vehicle driving apparatus according to claim 4, wherein the power wiring space is a space formed by a chamfered part that is formed by chamfering at least a part of an upper end of the power transmission mechanism.

7. The vehicle driving apparatus according to claim 3, wherein the power transmission mechanism comprises a final shaft that transmits rotation generated by power of the electric motor to a drive wheel of the vehicle, and
the power wiring space is arranged above the final shaft in the power transmission mechanism.

8. The vehicle driving apparatus according to claim 4, wherein the power transmission mechanism comprises a final shaft that transmits rotation generated by power of the electric motor to a drive wheel of the vehicle, and
the power wiring space is arranged above the final shaft in the power transmission mechanism.

9. The vehicle driving apparatus according to claim 1, wherein the power transmission mechanism integrally comprises a component of a parking mechanism for performing parking lock of the vehicle, and
the power wiring space and the component of the parking mechanism are provided on opposite sides of the power transmission mechanism in a front-rear direction of the vehicle.

10. The vehicle driving apparatus according to claim 3, wherein the power transmission mechanism integrally comprises a component of a parking mechanism for performing parking lock of the vehicle, and
the power wiring space and the component of the parking mechanism are provided on opposite sides of the power transmission mechanism in a front-rear direction of the vehicle.

11. The vehicle driving apparatus according to claim 4, wherein the power transmission mechanism integrally comprises a component of a parking mechanism for performing parking lock of the vehicle, and
the power wiring space and the component of the parking mechanism are provided on opposite sides of the power transmission mechanism in a front-rear direction of the vehicle.

12. The vehicle driving apparatus according to claim 5, wherein the power transmission mechanism integrally comprises a component of a parking mechanism for performing parking lock of the vehicle, and
the power wiring space and the component of the parking mechanism are provided on opposite sides of the power transmission mechanism in a front-rear direction of the vehicle.

13. The vehicle driving apparatus according to claim 6, wherein the power transmission mechanism integrally comprises a component of a parking mechanism for performing parking lock of the vehicle, and
the power wiring space and the component of the parking mechanism are provided on opposite sides of the power transmission mechanism in a front-rear direction of the vehicle.
